(19) United States
(12) Patent Application Publication
(10) Pub. No.: US 2008/0147669 A1
(43) Pub. Date: Jun. 19, 2008

(54) DETECTING WEB SPAM FROM CHANGES TO LINKS OF WEB SITES

(75) Inventors: Tie-Yan Liu, Beijing (CN); Bin Gao, Beijing (CN); Guoyang Shen, Beijing (CN); Wei-Ying Ma, Beijing (CN); Amit Aggarwal, Bellevue, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/611,113

(22) Filed: Dec. 14, 2006

(51) Int. Cl. G06F 17/30

(52) U.S. Cl. 707/10

(57) ABSTRACT

A method and system for determining whether a web site is a spam web site based on analysis of changes in link information over time is provided. A spam detection system collects link information for a web site at various times. The spam detection system extracts one or more features from the link information that relate to changes in the link information over time. The spam detection system then generates an indication of whether the web site is a spam web site using a classifier that has been trained to detect whether the extracted feature indicates that the web site is likely to be spam.

### BACKGROUND

Many search engine services, such as Google and Overture, provide for searching for information that is accessible via the Internet. These search engine services allow users to search for display pages, such as web pages, that may be of interest to users. After a user submits a search request (i.e., a query) that includes search terms, the search engine service identifies web pages that may be related to those search terms. To quickly identify related web pages, the search engine services may maintain a mapping of keywords to web pages. This mapping may be generated by “crawling” the web (i.e., the World Wide Web) to identify the keywords of each web page. To crawl the web, a search engine service may use a list of root web pages to identify all web pages that are accessible through those root web pages. The keywords of any particular web page can be identified using various well-known information retrieval techniques, such as identifying the words of a headline, the words supplied in the metadata of the web page, the words that are highlighted, and so on. The search engine service identifies web pages that may be related to the search request based on how well the keywords of a web page match the words of the query. The search engine service then displays to the user links to the identified web pages in an order that is based on a ranking that may be determined by their relevance to the query, popularity, importance, and/or some other measure.

Three well-known techniques for page ranking are PageRank, HITS (“Hyperlink-Induced Topic Search”), and DirectHIT. PageRank is based on the principle that web pages will have links to (i.e., “out links”) important web pages. Thus, the importance of a web page is based on the number and importance of other web pages that link to that web page (i.e., “in links”). In a simple form, the links between web pages can be represented by adjacency matrix A, where Aᵢⱼ represents the number of out links from web page i to web page j. The importance score wⱼ for web page j can be represented by the following equation:

wⱼ=ΕᵢAᵢⱼwᵢ

This equation can be solved by iterative calculations based on the following equation:

A^{T}w=w

where w is the vector of importance scores for the web pages and is the principal eigenvector of A^{T}.

The HITS technique is additionally based on the principle that a web page that has many links to other important web pages may itself be important. Thus, HITS divides “importance” of web pages into two related attributes: “hub” and “authority.” “Hub” is measured by the “authority” score of the web pages that a web page links to, and “authority” is measured by the “hub” score of the web pages that link to the web page. In contrast to PageRank, which calculates the importance of web pages independently from the query, HITS calculates importance based on the web pages of the result and web pages that are related to the web pages of the result by following in links and out links. HITS submits a query to a search engine service and uses the web pages of the result as the initial set of web pages. HITS adds to the set those web pages that are the destinations of in links and those web pages that are the sources of out links of the web pages of the result. HITS then calculates the authority and hub score of each web page using an iterative algorithm. The authority and hub scores can be represented by the following equations:

$$a ( p ) = {\sum }_{q \to p} h ( q ) and h ( p ) = {\sum }_{p \to q} a ( q )$$

where a(p) represents the authority score for web page p and h(p) represents the hub score for web page p. HITS uses an adjacency matrix A to represent the links. The adjacency matrix is represented by the following equation:

$${b}_{ij} = \{ \begin{matrix}1 if page i has a link to page j , \\ 0 otherwise\end{matrix}$$

The vectors a and h correspond to the authority and hub scores, respectively, of all web pages in the set and can be represented by the following equations:

a=A^{T}h and h=Aa

Thus, a and h are eigenvectors of matrices A^{T}A and AA^{T}. HITS may also be modified to factor in the popularity of a web page as measured by the number of visits. Based on an analysis of click-through data, bᵢⱼ of the adjacency matrix can be increased whenever a user travels from web page i to web page j.

Although these techniques for ranking web pages based on analysis of links can be very useful, these techniques are susceptible to “link spamming.” “Spamming” in general refers to a deliberate action taken to unjustifiably increase the popularity or importance of a web page or web site. In the case of link spamming, a spammer can manipulate links to unjustifiably increase the importance of a web page. For example, a spammer may increase a web page's hub score by adding out links to the spammer's web page. A common technique for adding out links is to create a copy of an existing link directory to quickly create a very large out link structure. As another example, a spammer may provide a web page of useful information with hidden links to spam web pages. When many web pages may point to the useful information, the importance of the spam web pages is indirectly increased. As another example, many web sites, such as blogs and web directories, allow visitors to post links. Spammers can post links to their spam web pages to directly or indirectly increase the importance of the spam web pages. As another example, a group of spammers may set up a link exchange mechanism in which their web sites point to each other to increase the importance of the web pages of the spammers' web sites.

Web spam, and in particular link spamming, presents problems for various techniques that rely on web data. For example, a search engine service that orders search results in part based on popularity or importance of web pages may rank spam web pages unjustifiably high because of the spamming. As another example, a web crawler may spend valuable time crawling the links of spam web sites, which increases the overall cost of web crawling and may reduce its effectiveness. Some techniques have been developed to try to combat link spamming. For example, one technique analyzes a web graph to detect particular link structures that may be indicative of link spamming. Current techniques for detecting link spam typically are typically designed to detect known link spamming techniques. Link spammers, however, continually try to develop new spamming techniques to circumvent current detection techniques.

### SUMMARY

A method and system for determining whether a web site is a spam web site based on analysis of changes in link information over time is provided. A spam detection system collects link information for a web site at various times. The spam detection system extracts one or more features from the link information that relate to changes in the link information over time. The spam detection system then generates an indication of whether the web site is a spam web site based on analysis of the extracted feature.

The spam detection system generates an indication of whether a web site is spam using a classifier that is trained using the link structure of web sites collected at various snapshot times. The spam detection system identifies training web sites to be used in training the classifier. The spam detection system then inputs a label for each training web site indicating whether the training web site is a spam web site. The spam detection system then extracts various features for each training web site. The features represent changes to the link structure over time that may in some way be associated with the web site. The spam detection system then trains a classifier using various techniques such as a support vector machine, neural network, adaptive boosting, and so on. The spam detection system then uses the trained classifier to automatically determine whether the non-training data web sites are spam.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagram that illustrates a portion of a web graph.

FIG. 2 is a block diagram that illustrates components of the spam detection system in one embodiment.

FIG. 3 is a flow diagram that illustrates the processing of the generate classifier component of the spam detection system in one embodiment.

FIG. 4 is a flow diagram that illustrates the processing of the generate training data component of the spam detection system in one embodiment.

FIG. 5 is a flow diagram that illustrates the processing of the generate feature vector component of the spam detection system in one embodiment.

FIG. 6 is a flow diagram that illustrates the processing of the classify web sites component of the spam detection system in one embodiment.

### DETAILED DESCRIPTION

A method and system for determining whether a web site is a spam web site based on analysis of changes in link information over time is provided. In one embodiment, a spam detection system collects link information for a web site at various times. The link information may include the source and target of each in and out link, respectively. The spam detection system extracts one or more features from the link information that relate to changes in the link information over time. For example, the spam detection system may calculate the link growth rate for a web site (i.e., rate at which new out links are added to the web site). The spam detection system then generates an indication of whether the web site is a spam web site based on analysis of the extracted feature. For example, if a web site has a dramatic increase in the number of out links, then the web site is more likely a spam web site. In one embodiment, the spam detection system generates an indication of whether a web site is spam using a classifier that is trained using the link structure of web sites collected at various snapshot times. For example, the spam detection system may crawl the web on a periodic basis (e.g., monthly) and create snapshots of the web structure, which may be represented as a web graph. A web graph represents web sites as vertices of the graph and links between web pages of the web sites as edges between the vertices. The edges are directed to differentiate in and out links. A web graph can be represented as an adjacency matrix. The spam detection system then identifies training web sites to be used in training the classifier. The spam detection system then inputs a label for each training web site indicating whether the training web site is a spam web site. For example, a person may manually review the training web sites and decide whether each training web site is spam. The spam detection system then extracts various features for each training web site. The features represent changes to the link structure over time that may in some way be associated with the web site. For example, a feature of link information of a web site may the average link growth rates of other web sites that point to the web site. The spam detection system then trains a classifier using various techniques such as a support vector machine, neural network, adaptive boosting, and so on. The spam detection system may then use the trained classifier to automatically determine whether the non-training data web sites are spam. Determining whether a web site is spam is useful in many applications such as web searching and web crawling. In this way, the spam detection system can base web site spam detection on temporal changes to the link structure of the web, rather than analysis of a static link structure.

In one embodiment, the spam detection system extracts features of link information of web sites that are categorized as direct features, neighbor features, correlation features, clustering features, and combined features. The direct features of a web site may include in link growth rate, out link growth rate, in link death rate, and out link death rate, which represent the rates at which links are added to or removed. The neighbor features of a web site may include the mean of the direct features of the sources of the in links and the targets of the out links of the web site. The correlation features of a web site may include the variance of the direct features of the sources of the in links and the targets of the out links of the web site. The clustering feature of a web site may include the rate of change of the clustering coefficient of the web site and its neighboring web sites. The combine features of a web site may include various combinations of the direct features, neighbor features, correlation features, and clustering features.

### Direct Features

The in link growth rate of a web site from one snapshot time to another snapshot time represents the rate at which the number of new in links to the web site has grown. The in link growth rate may be defined as the number of in links present at the second snapshot time that were not present at the first snapshot time divided by the number of in links at the first snapshot time. The in link growth rate is represented by the following equation:

$$IGR ( a ) = \frac{\vert {S}_{in} ( a , {t}_{1} ) \vert - \vert {S}_{in} ( a , {t}_{0} ) ⋂ {S}_{in} ( a , {t}_{1} ) \vert}{\vert {S}_{in} ( a , {t}_{0} ) \vert}$$

where IGR(a) represents the in link growth rate of web site a, Sᵢₙ(a,t) represents the source web sites of the in links to web site a at time t, and |Sᵢₙ(a,t)| represents the number of source web sites of the in links to web site a at time t. The in link death rate of a web site from one snapshot time to another snapshot time represents the rate at which the number of old in links to a web site has decreased. The in link death rate may be defined as the number of source web sites of in links that were present at the first snapshot time but are not present at the second snapshot time divided by the number of in links at the first snapshot time. The in link death rate is represented by the following equation:

$$IDR ( a ) = \frac{\vert {S}_{in} ( a , {t}_{0} ) \vert - \vert {S}_{in} ( a , {t}_{0} ) ⋂ {S}_{in} ( a , {t}_{1} ) \vert}{\vert {S}_{in} ( a , {t}_{0} ) \vert}$$

where IDR(a) represents the in link death rate of web site a. The out link death rate of a web site from one snapshot time to another snapshot time represents the rate at which the number of new out links from the web site has grown. The out link growth rate may be defined as the number of out links present at the second snapshot time that were not present at the first snapshot time divided by the number of out links present at the first snapshot time. The out link growth rate is represented by the following equation:

$$OGR ( a ) = \frac{\vert {S}_{out} ( a , {t}_{1} ) \vert - \vert {S}_{out} ( a , {t}_{0} ) ⋂ {S}_{out} ( a , {t}_{1} ) \vert}{\vert {S}_{out} ( a , {t}_{0} ) \vert}$$

where OGR(a) represents the out link growth rate of web site a and Sₒᵤₜ(a,t) represents the target web sites of the out links from web site a at time t, and |Sₒᵤₜ(a,t)| represents the number of target web sites of out links from web site a at time t. The out link death rate of a web site from one snapshot time to another snapshot time represents the rate at which the number of old out links to a web site has decreased. The out link death rate may be defined as the number of target web sites of out links that were present in the first snapshot time but are not present in the second snapshot time divided by the number of out links present at the first snapshot time. The out link death rate is represented by the following equation:

$$ODR ( a ) = \frac{\vert {S}_{out} ( a , {t}_{0} ) \vert - \vert {S}_{out} ( a , {t}_{0} ) ⋂ {S}_{out} ( a , {t}_{1} ) \vert}{\vert {S}_{out} ( a , {t}_{0} ) \vert}$$

where ODR(a) represents the out link death rate of web site a.

### Neighbor Features

The in link growth rate mean of a web site from one snapshot time to another snapshot time represents the mean of the in link growth rate of the web sites that are source web sites of in links to the web site. The in link growth rate mean is represented by the following equation:

$$IGRMean ( a ) = \frac{{\sum }_{b ∈ {S}_{in} ( a , {t}_{0} )} IGR ( b )}{\vert {S}_{in} ( a , {t}_{0} ) \vert}$$

where IGRMean(a) represents the in link growth rate mean for web site a. The in link death rate mean of a web site from one snapshot time to another snapshot time represents the mean of the in link death rate of the web sites that are source web sites of in links to the web site. The in link death rate mean is represented by the following equation:

$$IDRMean ( a ) = \frac{{\sum }_{b ∈ {S}_{in} ( a , {t}_{0} )} IDR ( b )}{\vert {S}_{in} ( a , {t}_{0} ) \vert}$$

where IDRMean(a) represents the in link death rate mean for web site a. The out link growth rate mean of a web site from one snapshot time to another snapshot time represents the mean of the out link growth rates of the web sites that are source web sites of in links to the web site. The out link growth rate mean is represented by the following equation:

$$OGRMean ( a ) = \frac{{\sum }_{b ∈ {S}_{in} ( a , {t}_{0} )} OGR ( b )}{\vert {S}_{in} ( a , {t}_{0} ) \vert}$$

where OGRMean(a) represents the out link growth rate mean for web site a. The out link death rate mean of a web site from one snapshot time to another snapshot time represents the mean of the out link death rate of the web sites that are source web sites of in links from the web site. The out link death rate mean is represented by the following equation:

$$ODRMean ( a ) = \frac{{\sum }_{b ∈ {S}_{in} ( a , {t}_{0} )} ODR ( b )}{\vert {S}_{in} ( a , {t}_{0} ) \vert}$$

where ODRMean(a) represents the out link death rate mean for web site a.

### Correlation Features

The in link growth rate variance of a web site from one snapshot time to another snapshot time represents the variance of the in link growth rates of source web sites of in links to the web site. The in link growth rate variance is represented by the following equation:

$$IGRVar ( a ) = \sqrt{\frac{{\sum }_{b ∈ {S}_{in} ( a , {t}_{0} )} {( IGR ( b ) - IGRMean ( a ) )}^{2}}{\vert {S}_{in} ( a , {t}_{0} ) \vert}}$$

where IGRVar(a) represents the in link growth rate variance for web site a. The in link death rate variance of a web site from one snapshot time to another snapshot time represents the variance of the in link death rates of source web sites of in links to the web site. The in link death rate variance is represented by the following equation:

$$IDRVar ( a ) = \sqrt{\frac{{\sum }_{b ∈ {S}_{in} ( a , {t}_{0} )} {( IDR ( b ) - IDRMean ( a ) )}^{2}}{\vert {S}_{in} ( a , {t}_{0} ) \vert}}$$

where IDRVar(a) represents the in link death rate variance for web site a. The out link growth rate variance of a web site from one snapshot time to another snapshot time represents the variance of the out link growth rates of source web sites of in links from the web site. The out link growth rate variance is represented by the following equation:

$$OGRVar ( a ) = \sqrt{\frac{{\sum }_{b ∈ {S}_{in} ( a , {t}_{0} )} {( OGR ( b ) - OGRMean ( a ) )}^{2}}{\vert {S}_{in} ( a , {t}_{0} ) \vert}}$$

where OGRVar (a) represents the out link growth rate variance for web site a. The out link death rate variance of a web site from one snapshot time to another snapshot time represents the variance of the out link death rates of source web sites of in links from the web site. The out link death rate variance is represented by the following equation:

$$ODRVar ( a ) = \sqrt{\frac{{\sum }_{b ∈ {S}_{in} ( a , Feb )} {( ODR ( {t}_{0} ) - ODRMean ( a ) )}^{2}}{\vert {S}_{in} ( a , {t}_{0} ) \vert}}$$

where ODRVar (a) represents the out link death rate variance for web site a.

### Clustering Features

The rate of change of the clustering coefficient of a web site from one snapshot time to another snapshot time represents the difference in the clustering coefficient of the web site between the first snapshot time and the second snapshot time divided by the clustering coefficient at the first snapshot time. The clustering coefficient is represented by the following equation:

$$CC ( a , t ) = \frac{\vert \{ ( b , c ) ∈ G ( t ) \vert b , c ∈ {S}_{in} ( a , t ) \} \vert}{\vert {S}_{in} ( a , t ) \vert \cdot ( \vert {S}_{in} ( a , t ) \vert - 1 )}$$

where CC(a,t) represents the clustering coefficient for web site a at time t and G(t) represents the web graph at time t. The rate of change of the clustering coefficient is represented by the following equation:

$$CRCC ( a ) = \frac{CC ( a , {t}_{1} ) - CC ( a , {t}_{0} )}{CC ( a , {t}_{0} )}$$

where CRCC(a) represents the rate of change of the clustering coefficient for web site a.

In one embodiment, the spam detection system generates features based on four web graphs G1, G2, G3, and G4 collected at four snapshot times. The spam detection system generates each feature for each adjacent pair of web graphs: (G1, G2), (G2, G3), and (G3, G4). The spam detection system also generates various combined features by combining various combinations of these features. Table 1 illustrates the combined features used by the spam detection system in one embodiment. The spam detection system generates each combined feature for each web graph pair indicated by combining the first and second features using the combination technique. For example, the spam detection system generates the first combined feature for each of web graph pair (G1, G2), (G2, G3), and (G3, G4) by multiplying the IGR feature by the IDR feature for each web graph pair. As another example, the spam detection system generates the third combined feature by dividing the IDRMean by the IDR for web graph pairs (G1, G2) and (G3, G4). Thus, the spam detection system uses 43 combined features in one embodiment.

TABLE 1

| | | | Combi- | |
|---|---|---|---|---|
| Com- | | | nation | |
| bined | First | Second | Tech- | Web Graph |
| Feature | Feature | Feature | nique | Pairs |
| 1 | IGR | IDR | multiply | (G1, G2), (G2, G3), (G3, G4) |
| 2 | IGR | IDR | divide | (G1, G2), (G2, G3), (G3, G4) |
| 3 | IDRMean | IDR | divide | (G1, G2), (G3, G4) |
| 4 | IDRVar | IDR | divide | (G1, G2), (G2, G3), (G3, G4) |
| 5 | IGRMean | IGR | divide | (G1, G2), (G2, G3), (G3, G4) |
| 6 | IGRVar | IGR | divide | (G1, G2), (G2, G3), (G3, G4) |
| 7 | IGRMean | IDRMean | multiply | (G1, G2), (G2, G3), (G3, G4) |
| 8 | IGRMean | IDRMean | divide | (G1, G2), (G2, G3), (G3, G4) |
| 9 | IGRVar | IDRVar | multiply | (G2, G3), (G3, G4) |
| 10 | IGRVar | IDRVar | divide | (G1, G2), (G2, G3), (G3, G4) |
| 11 | OGR | ODR | multiply | (G2, G3) |
| 12 | OGR | ODR | divide | (G1, G2), (G2, G3), (G3, G4) |
| 13 | OGRMean | ODRMean | multiply | (G1, G2), (G2, G3), (G3, G4) |
| 14 | OGRMean | ODRMean | divide | (G1, G2), (G2, G3), (G3, G4) |
| 15 | OGRVar | ODRVar | multiply | (G2, G3), (G3, G4) |
| 16 | OGRVar | ODRVar | divide | (G1, G2), (G2, G3), (G3, G4) |

One skilled in the art will appreciate that fewer or more features may be used to represent the link information of the web sites. Also, the features can be redefined in various ways. For example, the in link growth rate for a web site derived from G1 and G2 may be redefined to represent the total number of in links rather than just the number of web sites that have in links to the web site. In such a case, a web site with multiple out links to the web site will contribute more than one to the total number of in links. Also, the spam detection system may use any number of pairs of web graphs as the source of training data.

The spam detection system may use various techniques to train the classifier to classify web sites as spam. The classifier may be trained to generate discrete values (e.g., 1 or 0) indicating whether or not a web site is spam or continuous values (e.g., between 0 and 1) indicating the likelihood that a web site is spam. The spam detection system may use support vector machine techniques to train the classifier. A support vector machine operates by finding a hyper-surface in the space of possible inputs. The hyper-surface attempts to split the positive examples (e.g., features of non-spam web sites) from the negative examples (e.g., features of spam web sites) by maximizing the distance between the nearest of the positive and negative examples to the hyper-surface. This allows for correct classification of data that is similar to but not identical to the training data. Various techniques can be used to train a support vector machine. One technique uses a sequential minimal optimization algorithm that breaks the large quadratic programming problem down into a series of small quadratic programming problems that can be solved analytically. (See Sequential Minimal Optimization, at http://research.microsoft.com/˜jplatt/smo.html.)

The spam detection system may alternatively use an adaptive boosting technique to train the classifier. Adaptive boosting is an iterative process that runs multiple tests on a collection of training data. Adaptive boosting transforms a weak learning algorithm (an algorithm that performs at a level only slightly better than chance) into a strong learning algorithm (an algorithm that displays a low error rate). The weak learning algorithm is run on different subsets of the training data. The algorithm concentrates more and more on those examples in which its predecessors tended to show mistakes. The algorithm corrects the errors made by earlier weak learners. The algorithm is adaptive because it adjusts to the error rates of its predecessors. Adaptive boosting combines rough and moderately inaccurate rules of thumb to create a high-performance algorithm. Adaptive boosting combines the results of each separately run test into a single, very accurate classifier.

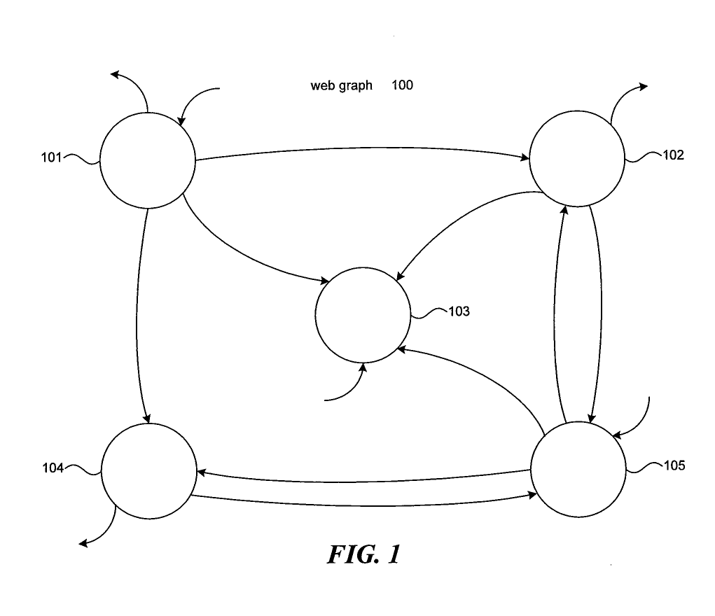

FIG. 1 is a diagram that illustrates a portion of a web graph. A web graph is generated by crawling the web and identifying the out links on web pages of web sites that are encountered. In this example, a portion of web graph 100 contains vertices 101-105 representing five web sites and edges between the vertices representing out links. For example, the edge between vertices 101 and 103 represents an out link of the web site represented by vertex 101 to the web site represented by vertex 103. Thus, the web site represented by vertex 103 is the target of the out link represented by the edge. That same edge is also an in link to the web site represented by vertex 103. Thus, the web site represented by vertex 101 is the source of the in link represented by the edge. The spam detection system may represent the web graph using an adjacency matrix with each web site represented as a row and a column of the matrix. A nonzero entry for a row and a column may indicate that the web site represented by the row has an out link to the web site represented by that column. The spam detection system may use various techniques to represent web graphs including sparse matrix storage techniques. The spam detection system may also store differences between the web graph from one snapshot time to the next snapshot rather than storing the entire web graph multiple times.

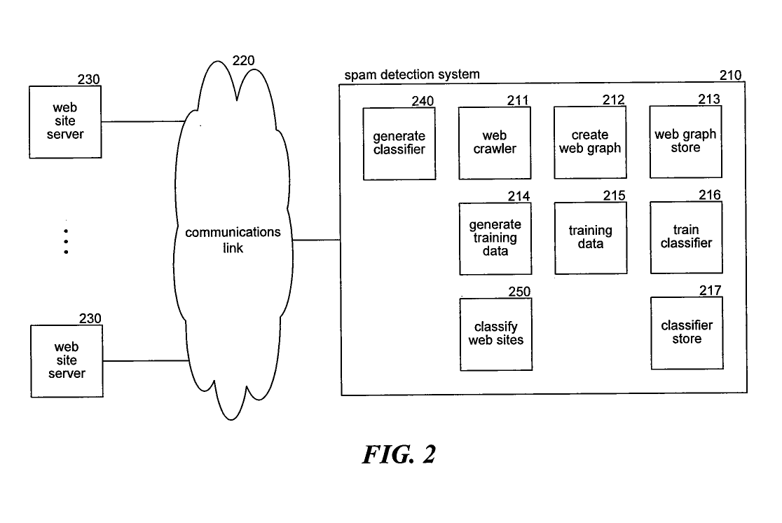

FIG. 2 is a block diagram that illustrates components of the spam detection system in one embodiment. The spam detection system 210 is connected to web site servers 230 via communications link 220. The spam detection system crawls the web site servers to collect training data for training a classifier, trains the classifier, and then classifies non-training data web sites as spam or not spam. The classifier may generate a score indicating the likelihood that a web site is spam. The spam detection system includes a generate classifier component 240 and a classify web sites component 250. The generate classifier component invokes various components of the detection system to generate a classifier. The spam detection system also includes a web crawler component 211, a create web graph component 212, and a web graph store 213. The web crawler component is invoked to crawl the web and provide the out link information of web sites. The create web graph component creates an adjacency matrix indicating the link information of the crawled web sites and stores the adjacency matrix in the web graph store. The spam detection system also includes a generate training data component 214, a training data store 215, a train classifier component 216, and a classifier store 217. The generate training data component generates training data for training web sites that include labels and their extracted features and stores the training data in the training data store. The train classifier component uses the training data to train a classifier to detect a web site as being spam and stores the parameters for the trained classifier in the classifier store. The classify web sites component inputs link information for a web site, extracts the features, and classifies the web site by applying the trained classifier to the features.

The computing device on which the spam detection system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the spam detection system, which means a computer-readable medium that contains the instructions. In addition, the instructions, data structures, and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the spam detection system may be implemented in various operating environments that include personal computers, server computers, hand-held or laptop devices, multiprocessor systems, microprocessor-based systems, programmable consumer electronics, digital cameras, network PCs, minicomputers, mainframe computers, cell phones, personal digital assistants, smart phones, personal computers, programmable consumer electronics, distributed computing environments that include any of the above systems or devices, and so on.

The spam detection system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments. For example, a separate computing system may crawl the web and generate the web graphs. Also, the generation of the classifier may be separate from the classification of the web sites. For example, one company may generate a classifier and distribute the classifier to other companies for use in various applications, such as blocking access of users to spam web sites or shutting down spam web sites.

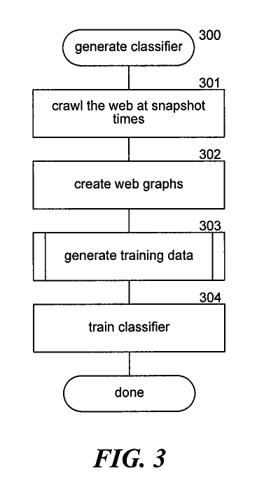

FIG. 3 is a flow diagram that illustrates the processing of the generate classifier component 300 of the spam detection system in one embodiment. The generate classifier component controls various components of the spam detection system to collect training data and train a classifier. In block 301, the component crawls the web at several snapshot times to collect link information for use in deriving training data. In block 302, the component creates a web graph from the link information for each snapshot time. In block 303, the component invokes a generate training data component to generate training data by extracting the features and labeling the training web sites. In block 304, the component trains the classifier using the training data and then completes.

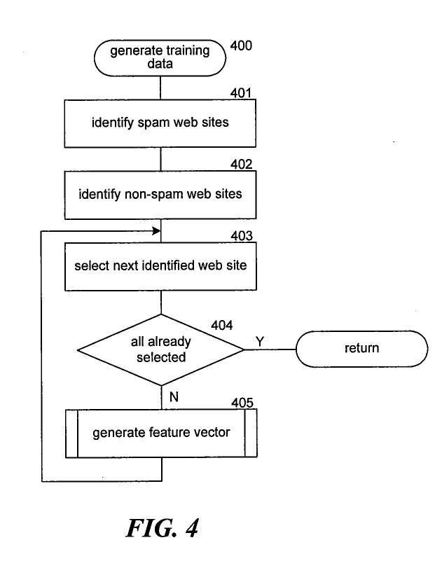

FIG. 4 is a flow diagram that illustrates the processing of the generate training data component 400 of the spam detection system in one embodiment. The generate training data component identifies spam web sites and non-spam web sites and generates a feature vector for each identified web site. In block 401, the component identifies spam web sites from the training web sites. In block 402, the component identifies non-spam web sites from the training web sites. In blocks 403-405, the component loops generating a feature vector for each identified web site. In block 403, the component selects the next identified web site. In decision block 404, if all the identified web sites have already been selected, then the component returns, else the component continues at block 405. In block 405, the component invokes the generate feature vector component to generate a feature vector for the selected web site and then loops to block 403 to select the next identified web site.

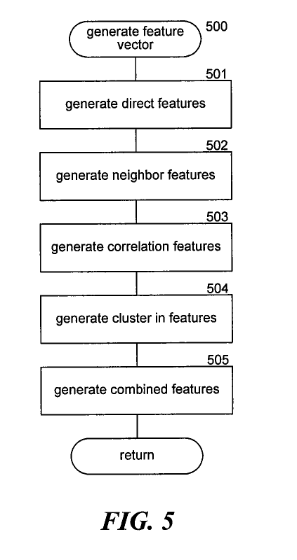

FIG. 5 is a flow diagram that illustrates the processing of the generate feature vector component 500 of the spam detection system in one embodiment. The component is passed an indication of a web site and a pair of web graphs and generates various features for the web site. In block 501, the component generates the direct features of the web site. In block 502, the component generates the neighbor features of the web site. In block 503, the component generates the correlation features of the web site. In block 504, the component generates the clustering features of the web site. In block 505, the component generates the combined features of the web site and then returns.

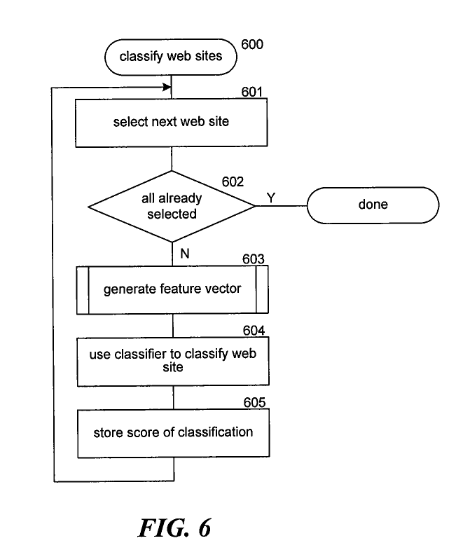

FIG. 6 is a flow diagram that illustrates the processing of the classify web sites component 600 of the spam detection system in one embodiment. The component is passed an indication of web sites that are to be classified as to their likelihood of being spam. In block 601, the component selects the next web site. In decision block 602, if all the web sites have already been selected, then the component completes, else the component continues at block 603. In block 603, the component invokes the generate feature vector component to generate the features for the selected web site. In block 604, the component uses the classifier to classify the web site based on the features. In block 605, the component stores a score indicating the classification of the web site as spam and then loops to block 601 to select the next web site.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. For example, the principles of the spam detection system can be applied to train a classifier to detect whether a web site satisfies an arbitrary criterion based on temporal changes to the link information of the web sites. The training web sites can be labeled as to whether they meet the criterion such as important or popular web sites. The labels along with the features, which may be chosen based on the criterion, are used to train the classifier. As another example, the principles of the spam detection system may also be used to train a classifier to detect whether a web page, or more generally a web document, is spam regardless of whether its web site is spam. Accordingly, the invention is not limited except as by the appended claims.

I/We claim:

1. A computer system for determining whether a web site is a spam web site, comprising:
a component that collects link information for the web site at a plurality of snapshot times;
a component that extracts a feature of the link information indicating changes to the link information at the snapshot times; and
a component that generates, based on the extracted feature, an indication of whether the web site is a spam web site.

2. The computer system of claim 1 including
a link information store of training web sites;
a component that provides, for training web sites, labels indicating whether the web sites are spam;
a component that extracts, for training web sites, features of the link information of the training web sites; and
a component that trains a classifier to classify whether a web site is spam using the extracted features and the labels of the training web sites.

3. The computer system of claim 2 wherein the extracted features include features for both in links and out links.

4. The computer system of claim 2 wherein the extracted features include features selected from the group consisting of direct features, neighbor features, correlation features, clustering features, and combined features.

5. The computer system of claim 2 wherein the component that generates applies the classifier to the extracted feature of the web site to determine whether the web site is spam.

6. The computer system of claim 1 including a component that ranks search results of web pages based on the indication of whether the web site of a web page is spam.

7. The computer system of claim 1 including a component that, when crawling web sites, suppresses the crawling of a web site when the indication indicates that the web site is a spam web site.

8. The computer system of claim 1 including
a link information store of training web sites;
a component that provides, for training web sites, labels indicating whether the web sites are spam;
a component that extracts, for training web sites, features of the link information of the training web sites;
a component that trains a classifier to classify whether a web site is spam using the extracted features and the labels of the training web sites;
a component that applies the trained classifier to the extracted feature of the web site to determine whether the web site is spam; and
a component that ranks search results based on whether a web site associated with a search result is determined to be spam.

9. A computer system for determining whether a web document is spam, comprising:
a component that trains a classifier to indicate whether a web document is spam based on changes to link information of the web document over time;
link information for the web document for a plurality of times; and
a component that applies the trained classifier to the link information of the document to determine whether the web document is spam based on changes to the link information of the web document over time.

10. The computer system of claim 9 wherein the web document is a web page.

11. The computer system of claim 9 wherein the web document is a web site.

12. The computer system of claim 9 wherein the component that trains includes:
link information for training web documents at a plurality of snapshot times;
a label for each web document indicating whether the training web document is spam; and
a component that, for each training web document, extracts features of the training web document from the link information based on changes to link information over time so that the component that trains uses the extracted features and the labels of the training web documents.

13. The computer system of claim 12 wherein the web document is a web site and the extracted features include features selected from the group consisting of direct features, neighbor features, correlation features, clustering features, and combined features.

14. A computer-readable medium embedded with computer-executable instructions for controlling a computer system to determine whether a web site satisfies a criterion, by a method comprising:
for each of a plurality of training web sites,
providing web site link information at various times and a label indicating whether the training web site satisfies the criterion;
extracting features of the link information based on changes to link information over time;
training a classifier to determine whether a web site satisfies the criterion using the extracted features and labels of the training web sites;
extracting features of link information of the web site based on changes to link information over time; and
applying the trained classifier to the extracted features of the web site to determine whether the web site satisfies the criterion.

15. The computer-readable medium of claim 14 wherein the criterion is whether the web site is spam.

16. The computer-readable medium of claim 15 including ranking search results of web pages based on whether it is determined that the web site of the web page is a spam web site.

17. The computer-readable medium of claim 15 including when crawling web sites, suppressing the crawling of a web site when it is determined that the web site is spam.

18. The computer-readable medium of claim 14 wherein the extracted features include features selected from the group consisting of direct features, neighbor features, correlation features, clustering features, and combined features.

19. The computer-readable medium of claim 14 wherein the classifier is a support vector machine.

20. The computer-readable medium of claim 14 wherein the extracted features include growth rate and death rate of in links and out links.
